(19) United States
(12) Patent Application Publication
(10) Pub. No.: US 2021/0107804 A1
(43) Pub. Date: Apr. 15, 2021

(54) WASTE WATER FILTRATION COMPOSITIONS, SYSTEMS AND METHODS

(71) Applicant: Geraldo Roberto Silveira, Las Vegas, NV (US)

(72) Inventor: Geraldo Roberto Silveira, Las Vegas, NV (US)

(21) Appl. No.: 17/071,355

(22) Filed: Oct. 15, 2020

Related U.S. Application Data
(60) Provisional application No. 62/915,117, filed on Oct. 15, 2019.

(51) Int. Cl. C02F 1/00; B01D 39/20; C02F 1/28

(52) U.S. Cl. CPC C02F 1/001; C02F 2103/02; C02F 1/283; B01D 39/2058

(57) ABSTRACT

Provided are anti-pathogenic sintered nanoparticle compounds made of zeolite, silver nitrate (AgNO₃), silver dioxide nanoparticles (Ag₂O np), and graphene. Provided are enhanced granulated activated charcoal (EGAC) compounds made of granulated activated charcoal, silver nitrate (AgNO₃), silver dioxide nanoparticles (Ag₂O np), and graphene. Uses of the same are provided, including in enhanced filtration systems and/or pressurized wastewater filtration plants.

### CROSS-REFERENCE TO RELATED APPLICATIONS

This application claims benefit of U.S. Provisional Patent Application Ser. No. 62/915,117, filed Oct. 15, 2019, herein incorporated by reference in its entirety.

### TECHNICAL FIELD

Provided herein are waste water filtration compositions, systems and methods.

### BACKGROUND

There is a significant need for compositions, devices and systems for processing waste water to remove impurities and contaminants, particularly in municipal waste water systems. Large amounts of waste water must be processed in municipal systems, both to make the waste water safe for down-stream discharge, and/or for further use as pathogen-free water. Moreover, there is a continued need for effective and cost-efficient treatment compositions, systems, devices and methods for treating and/or disinfecting waste water.

### SUMMARY

This summary lists several embodiments of the presently disclosed subject matter, and in many cases lists variations and permutations of these embodiments. This summary is merely exemplary of the numerous and varied embodiments. Mention of one or more representative features of a given embodiment is likewise exemplary. Such an embodiment can typically exist with or without the feature(s) mentioned; likewise, those features can be applied to other embodiments of the presently disclosed subject matter, whether listed in this summary or not. To avoid excessive repetition, this Summary does not list or suggest all possible combinations of such features.

In some embodiments, provided herein are anti-pathogenic sintered nanoparticle compounds, comprising zeolite, silver nitrate (AgNO₃), silver dioxide nanoparticles (Ag₂O np), and graphene, wherein the zeolite is provided as a core element impregnated with a solution of AgNO₃ and Ag₂O np, wherein the impregnated zeolite core element is encapsulated in a monolayer graphene solution to form a sintered nanoparticle sterilizer. In some aspects, the zeolite is organic, synthetic or a combination thereof. In some embodiments, the anti-pathogenic sintered nanoparticle compound is configured to sterilize raw water. In some embodiments, the anti-pathogenic sintered nanoparticle compound is configured to be used in conjunction with a water filtration system. In some aspects, the zeolite comprises a uniform particle size.

In some aspects, methods of making an anti-pathogenic sintered nanoparticle compounds are provided herein. Such methods can comprise providing a zeolite, providing a silver nitrate (AgNO₃), providing a silver dioxide nanoparticles (Ag₂O np), providing a graphene, combining a core element of the zeolite with a solution of AgNO₃ and/or Ag₂O np, and mixing the solution to provide equal distribution, whereby the zeolite core is impregnated with the AgNO₃ and/or Ag₂O np. In some aspects, these methods further comprise encapsulating the impregnated zeolite core with a monolayer graphene solution to form a sintered nanoparticle sterilizer. In some embodiments, these methods further comprise placing the sintered nanoparticle in a negative pressure autoclave for an established period of time.

Disclosed herein are also enhanced granulated activated charcoal (EGAC) compounds, comprising granulated activated charcoal, silver nitrate (AgNO₃), silver dioxide nanoparticles (Ag₂O np), and graphene, wherein the granulated activated charcoal is provided as an inner core impregnated with a solution of AgNO₃ and Ag₂O np, wherein the impregnated granulated activated charcoal inner core is encapsulated in a monolayer graphene solution to form an EGAC. In some embodiments, the EGAC is configured to remove of nitrates, nitrites, salts, odors, and/or taste from processed water. In some embodiments, the EGAC compound is configured to be used in conjunction with a water filtration system, and/or with anti-pathogenic sintered nanoparticle compounds.

Also disclosed herein are methods of making enhanced granulated activated charcoal (EGAC) compound, comprising providing a granulated activated charcoal, providing a silver nitrate (AgNO₃), combining the granulated activated charcoal with a solution of AgNO₃ and mixing to uniformly combine them, providing a silver dioxide nanoparticles (Ag₂O np) and mixing it with the granulated activated charcoal and AgNO₃ composite, and placing the granulated activated charcoal with AgNO₃ and Ag₂O np in a negative pressure autoclave for an established period of time. In some embodiments, the method of making an EGAC compound further comprises providing a graphene, mixing the graphene with the granulated activated charcoal with AgNO₃ and Ag₂O np to substantially evenly coat the same.

In some aspects, provided herein are enhanced filtration systems, comprising an outer body of cylindrical shape comprising a screened, sintered porous metal, and/or porous media, an inner body of cylindrical shape comprising a screened, sintered porous metal, and/or porous media, a first nanoparticle sterilizer in a void area that lies axially between the inner and outer bodies of screened or sintered porous metal cylinders, an inner chamber positioned on an interior of and axially with the inner cylindrical body, and a second nanoparticle sterilizer in a void of the inner chamber. In some embodiments, the first and/or second nanoparticle sterilizer comprises an anti-pathogenic sintered nanoparticle compound of any of the above claims. In some embodiments, the enhanced filtration systems can further comprise a pleated paper filter along an axis of the outer and/or inner cylindrical body. In some embodiments, the enhanced filtration systems can further comprise a serrated outlet carrier pipe at either or both ends of the cylindrical body. In some embodiments, the enhanced filtration systems are configured to filter wastewater, organically contaminated with pathogens from an establishment, such as a single or multi family dwelling, pond, stream or floodwaters, so that the filtered water can be used for pathogen free water.

Disclosed herein are pressurized wastewater filtration plants, comprising a plurality of cylindrical processing vessels for progressive stages of filtration, comprising a first cylindrical vessel embodying a pair of filters mounted on a manifold and residing on the bottom of the vessel, a second cylindrical vessel embodying a single filter to perform a second stage filtration process, and a third cylindrical vessel containing one or more nanoparticle sterilizers, a pressurization system configured to pressurize one or more of the first, second and third cylindrical vessels, and one or more conveyance pipes to transfer wastewater between the one or more of the first, second and third cylindrical vessels. The one or more nanoparticle sterilizers can comprise an anti-pathogenic sintered nanoparticle compound of any of the above claims. In some aspects, the pressurized wastewater filtration plant can comprise an enhanced granulated activated charcoal (EGAC) compound. In some embodiments, the first cylindrical vessel can be pressurized by the pressurization system to about 10 to about 50 pounds. In some embodiments, the pressurization of the first cylindrical vessel forces the waste water from the first vessel to the second vessel, and from the second vessel to the third vessel. In some embodiments, the first vessel comprises a first sterilization compound, the second vessel comprises a second sterilization compound, optionally an anti-pathogenic sintered nanoparticle compound of any of the above claims, and the third vessel comprises an EGAC of any of the above claims. In some embodiments, the enhanced filtration system is configured to filter wastewater, organically contaminated with pathogens from an establishment, such as a single or multi family dwelling, pond, stream or floodwaters, so that the filtered water can be used for pathogen free water.

These and other embodiments are achieved in whole or in part by the presently disclosed subject matter. Further, objectives and embodiments of the presently disclosed subject matter having been stated above, other objects and advantages of the presently disclosed subject matter will become apparent to those skilled in the art after a study of the following description, Drawings and Examples.

### BRIEF DESCRIPTION OF THE DRAWINGS

The presently disclosed subject matter can be better understood by referring to the following figures. The components in the figures are not necessarily to scale, emphasis instead being placed upon illustrating the principles of the presently disclosed subject matter (often schematically). In the figures, like reference numerals designate corresponding parts throughout the different views. A further understanding of the presently disclosed subject matter can be obtained by reference to an embodiment set forth in the illustrations of the accompanying drawings. Although the illustrated embodiment is merely exemplary of systems for carrying out the presently disclosed subject matter, both the organization and method of operation of the presently disclosed subject matter, in general, together with further objectives and advantages thereof, may be more easily understood by reference to the drawings and the following description. The drawings are not intended to limit the scope of this presently disclosed subject matter, which is set forth with particularity in the claims as appended or as subsequently amended, but merely to clarify and exemplify the presently disclosed subject matter.

For a more complete understanding of the presently disclosed subject matter, reference is now made to the following drawings in which:

FIG. 1 is an isometric view of an inner filter system with some parts cut-away and some parts shown in section;

FIG. 2 is an orthographic view looking down at vulcanized cross laced screening;

FIG. 3 is an orthographic section view of the inner filter system, showing the outer screening, inner void area, and inner clean water outlet conveyance tube;

FIG. 4 is an isometric view of a filter system, with some parts cut-away showing a middle void area, and inner filter;

FIG. 5 is an orthographic sectional view showing outer screen of middle void area, inner void of the inner filter, inner filter, and inner clean water outlet conveyance tube;

FIG. 6 is an isometric view of components used in the present invention, with some parts cut-away to show outer screen and void area, middle screen and void area, inner screened filter element and clean water outlet conveyance tube;

FIG. 7 is an orthographic sectional view of components used in the present invention, showing outer screens and void area, middle screens and void area, inner screened filter element, a clean water outlet conveyance tube;

FIG. 8 Is an isometric view, partially sectioned, and partially cut-away to show all the components of the present invention, and directional flow of water through the filter system;

FIG. 9 is an orthographic sectional view of the completed present invention, shown in vertical position, with the clean water outlet conveyance tube capped at the top, and a fitting at the bottom for removal, that can be possibly used as a single, secondary filter system;

FIG. 10 is an isometric illustration of the entire system;

FIG. 11 is an isometric view of the primary vessel with cut-away view of filters;

FIG. 12 is an isometric view of the secondary vessel with cut-away view of filter; and

FIG. 13 is an isometric view of the tertiary vessel (reactor) with cut-away view of internal members.

### DETAILED DESCRIPTION

The presently disclosed subject matter now will be described more fully hereinafter, in which some, but not all embodiments of the presently disclosed subject matter are described. Indeed, the presently disclosed subject matter can be embodied in many different forms and should not be construed as limited to the embodiments set forth herein; rather, these embodiments are provided so that this disclosure will satisfy applicable legal requirements.

### I. Definitions

The terminology used herein is for the purpose of describing particular embodiments only and is not intended to be limiting of the presently disclosed subject matter.

While the following terms are believed to be well understood by one of ordinary skill in the art, the following definitions are set forth to facilitate explanation of the presently disclosed subject matter.

All technical and scientific terms used herein, unless otherwise defined below, are intended to have the same meaning as commonly understood by one of ordinary skill in the art. References to techniques employed herein are intended to refer to the techniques as commonly understood in the art, including variations on those techniques or substitutions of equivalent techniques that would be apparent to one skilled in the art. While the following terms are believed to be well understood by one of ordinary skill in the art, the following definitions are set forth to facilitate explanation of the presently disclosed subject matter.

In describing the presently disclosed subject matter, it will be understood that a number of techniques and steps are disclosed. Each of these has individual benefit and each can also be used in conjunction with one or more, or in some cases all, of the other disclosed techniques.

Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

Following long-standing patent law convention, the terms “a”, “an”, and “the” refer to “one or more” when used in this application, including the claims. Thus, for example, reference to “a unit cell” includes a plurality of such unit cells, and so forth.

Unless otherwise indicated, all numbers expressing quantities of ingredients, reaction conditions, and so forth used in the specification and claims are to be understood as being modified in all instances by the term “about”. Accordingly, unless indicated to the contrary, the numerical parameters set forth in this specification and attached claims are approximations that can vary depending upon the desired properties sought to be obtained by the presently disclosed subject matter.

As used herein, the term “about,” when referring to a value or to an amount of a composition, mass, weight, temperature, time, volume, concentration, percentage, etc., is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

As used herein, the term “substantially” or “substantially free,” or similar variants, when referring to a value, or more particularly absence of a pathogen, bacterial load or organism, is meant to encompass variations of in some embodiments ±20%, in some embodiments ±10%, in some embodiments ±5%, in some embodiments ±1%, in some embodiments ±0.5%, and in some embodiments ±0.1% from the specified amount. Thus, waste water treated by the disclosed compounds, devices and/or systems that is “substantially free” of pathogens and the like can in some embodiments be 100% free or devoid of pathogens, or about 99.9% free or devoid of pathogens, or about 99.5% free or devoid of pathogens, or about 99% free or devoid of pathogens, or about 98% free or devoid of pathogens, or about 95% free or devoid of pathogens, and so on.

The term “comprising”, which is synonymous with “including” “containing” or “characterized by” is inclusive or open-ended and does not exclude additional, unrecited elements or method steps. “Comprising” is a term of art used in claim language which means that the named elements are essential, but other elements can be added and still form a construct within the scope of the claim.

As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials or steps, plus those that do not materially affect the basic and novel characteristic(s) of the claimed subject matter.

With respect to the terms “comprising”, “consisting of”, and “consisting essentially of”, where one of these three terms is used herein, the presently disclosed and claimed subject matter can include the use of either of the other two terms.

As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C, and D.

### II. Waste Water Filtration Compositions, Systems and Methods

Multiple embodiments of compounds, elements, devices and systems directed to waste water treatment and/or sterilization are disclosed herein. For example, in some embodiments sintered nanoparticle sterilizers are disclosed herein. Moreover, in some embodiments enhanced granulated activated charcoal compounds and components are disclosed herein. Still yet, in some aspects, enhanced wastewater filtration systems are disclosed herein. Finally, in some aspects, pressurized wastewater filtration plants are provided herein.

a. Sintered Nanoparticle Sterilizer

In some embodiments sintered nanoparticle sterilizers and/or compounds are disclosed herein. More particularly, in some aspects a sintered nanoparticle compound can comprise a core element of organic or synthetic zeolite that can be impregnated with a solution of silver nitrate (AgNO₃), and in some embodiments can then be further impregnated with a silver dioxide nanoparticle (Ag₂O np), and encapsulated in a monolayer graphene solution to form a sintered nanoparticle sterilizer. In some aspects, a sintered nanoparticle compound can comprise zeolite, silver nitrate (AgNO₃), a silver dioxide nanoparticle (Ag₂O np), and graphene, wherein the zeolite is a core element impregnated with the AgNO₃ and the Ag₂O np, wherein the impregnated zeolite core element is encapsulated in a graphene monolayer to form a sintered nanoparticle.

Such a sintered nanoparticle sterilizer or compound can have sterilization and/or anti-pathogenic properties. As such, in some embodiments, the sintered nanoparticle sterilizer can be for the sterilization of pathogens from processed water. In some aspects, sintered nanoparticles can be used in conjunction with a water filtration system, including those disclosed herein.

To elaborate, a sintered nanoparticle sterilizer as disclosed herein can be used to assist in the sterilization of all organic pathogens contained in wastewater when used in conjunction with a water filtration system.

In some aspects, sintered nanoparticle sterilizers as disclosed herein can start with a generic organic, or specialized synthetic zeolite, assuming a uniform particle size. It can then be combined with a silver nitrate (AgNo3) solution, and mixed to uniformly coat and combine. This resulting compound can then be combined with silver oxide nanoparticles, and thoroughly mixed to provide equal distribution.

In another aspect, the above resulting compound of the sintered nanoparticle can be placed in a negative pressure autoclave for an established period of time, e.g. 10 minutes, 1 hour, 24 hours, or more. Moreover, in some aspects, a monolithic graphene solution can be added to the previously formed compound, and mixed for uniform distribution to assure about 100% coating of the compound, or substantially complete coating, e.g. 90%, 95%, 99%, etc. The resultant mixture can be placed in a negative pressure autoclave for an established length of time, e.g. 10 minutes, 1 hour, 24 hours, or more.

Finally, in some aspects, the resultant sintered compound can be cooled for usage.

b. Enhanced Granulated Activated Charcoal (EGAC)

Provided herein are enhanced granulated activated charcoal (EGAC) compounds that can, in some embodiments, comprise an inner core of granulated activated charcoal that can be impregnated with a solution of silver nitrate (AgNO₃), and may be then further impregnated with silver dioxide nanoparticle (Ag₂O np) and encapsulated in a monolayer graphene solution to form an enhanced GAC (EGAC).

One proposed use for the disclosed EGAC can in some embodiments include the final removal of nitrates, nitrites, salts, odors, and taste from processed water. In some embodiments, the EBAC can be used in conjunction with a water filtration system.

To elaborate, in some embodiments provided herein is an enhanced granulated activated charcoal compound configured to be used to assist in a final polishing of filtered water to remove any residual nitrates, nitrites, salts, odor, and taste, from filtered water processed when used in conjunction with a water filtration system.

One aspect of the disclosure includes, in some aspects, starting with a generic granulated activated charcoal powder, assuming a uniform particle size, then combining it with a silver nitrate (AgNO₃) solution, and mixing the two to uniformly coat and combine them. This resulting compound can then be combined with silver oxide nanoparticles (Ag₂O np), and thoroughly mixed to provide equal distribution.

The resulting compound can then be placed in a negative pressure autoclave for an established period of time, e.g. 10 minutes, 1 hour, 24 hours, or more.

Furthermore, in some embodiments a monolithic graphene solution can be added to the previously formed compound, and mixed for uniform distribution to assure about 100% coating of the compound, or substantially complete coating, e.g. 90%, 95%, 99%, etc. The resultant mixture can be placed in a negative pressure autoclave for an established length of time, e.g. 10 minutes, 1 hour, 24 hours, or more.

Finally, in some aspects, the resultant sintered compound can be cooled for usage.

c. Enhanced Wastewater Filter

In some embodiments, provided herein is an enhanced filtration system, that can have an outer body of cylindrical shape that may be screened, sintered porous metal, and/or similar porous media, so that waste water can pass through a first stage nanoparticle sterilizer in a void area that lies axially between the inner and outer screened or sintered porous metal cylinders, to an inner chamber, in some aspects of full length and cylindrical shape, along the same axis, that may also be wrapped with an outer screen, sintered porous metal, and/or similar porous media. In some aspects, the outer screened or sintered porous metal cylindrical device filters large particulate contained in a vessel of various size, that contains the processed wastewater that will pass through the outer screen, sintered porous metal, and/or similar porous media into the first void area. The first void area which the semi filtered processed wastewater passes through to a second screened, sintered porous metal, or other porous media chamber of full length, again of cylindrical shape, along the axis of the unit. This inner chamber can embody another nanoparticle sterilizer, to which the pathogen free water continues to pass through to a pleated paper, sintered porous metal, or other similar porous media filter that runs the full length along the same axis and is also screened or sintered porous metal. The filtered water then exits through a serrated outlet carrier pipe out both ends (for pleated paper filter only).

One proposed use for a system in accordance with the present disclosure is to treat wastewater organically contaminated with pathogens for use as pathogen free water, or substantially pathogen free water. In general, wastewater can be conveyed to a tank that embodies the proposed filter, to which the wastewater can pass through, to a secondary filtration tank, that comprises another filter.

In some aspects, two void areas within the filter can contain a nanoparticle sterilizer, as disclosed herein, that destroys the bacteria by elimination of the pathogen's free electron.

The forgoing aspects and many of the attendant advantages of this invention will become more readily appreciated as the same become better understood by reference to the drawings.

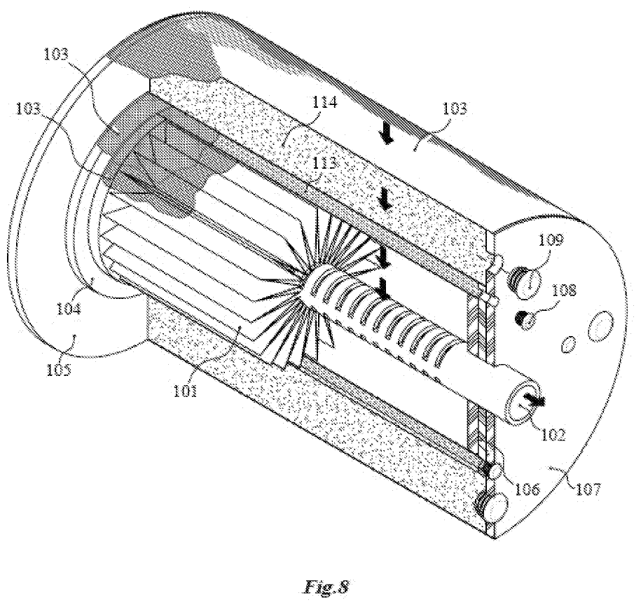

An enhanced primary filter system in accordance with the presented invention, that can be used to filter wastewater, organically contaminated with pathogens from an establishment, such as a single or multi family dwelling, or pond, stream or floodwaters (heron referred to as ‘wastewater’) so that the filtered water can be used for pathogen free water. The wastewater can be pumped directly from the source and conveyed to a holding tank where the presented invention is installed. With reference to FIG. 8, which illustrates directional flow of wastewater through to filtrate, the wastewater enters the outer screened area of the filter system 103, which prevents large particulate from entering the filter system. Wastewater then may pass through the first void area 114 containing a first nanoparticle sterilizer, as disclosed herein, where the wastewater then may pass through an inner void area 113, that may contain a second nanoparticle sterilizer (the same as or different from the first nanoparticle sterilizer), where it then can pass through an inner core filter 101 and further into a horizontal out-flow conveyance tube 102 which lies along the axis of the filter, and further exists both ends.

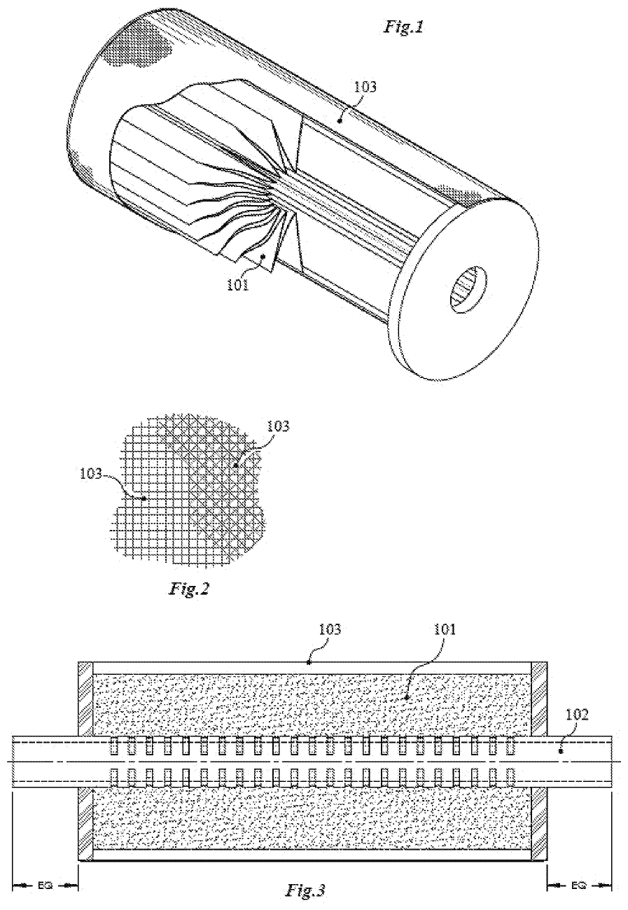

With reference to FIG. 1, one aspect of the instant disclosure is the final inner filter 101 which is an industry standard pleated paper filter, of designated size, with the pleated paper captured on both ends with round PVC ends, which features a hole in each that act as an outlet for the filtered water. The pleated filter is wrapped with a two-ply screen material 103 (see FIG. 2), fashioned by cutting two pieces of the screen material, and laying one piece diagonally over the other, and fused together, e.g. by a heated press. The screen wraps tightly around the PVC ends, and can be glued in place and trimmed to the ends of the filter. This produces a void area 110 between the pleated filter elements and the screens.

Another aspect of this invention is the clean filtered water conveyance tube 102 which resides along the axis of the filter and protrudes equal distance out of both ends, as shown in FIG. 3.

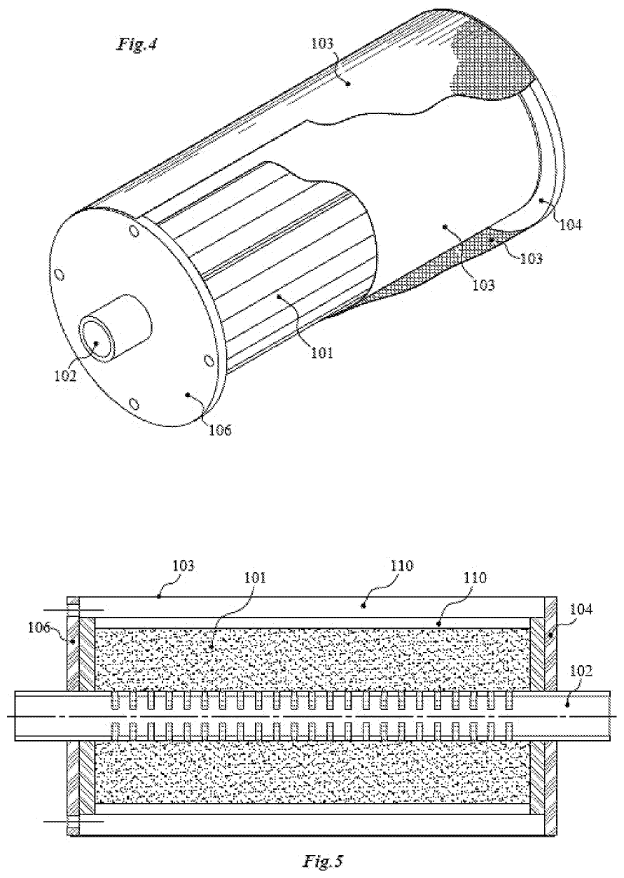

Turning now to FIG. 4, two PVC discs 104 with no holes, and 106 with holes, of a larger diameter, being about three quarters larger in diameter than the filter ends of the pleated filter 101, can be placed over the conveyance tube 102 and glued to the pleated filter ends. A two-ply screen system 103 can again be wrapped around the outer discs, glued and trimmed, as shown in FIG. 5. This creates a middle void area 110.

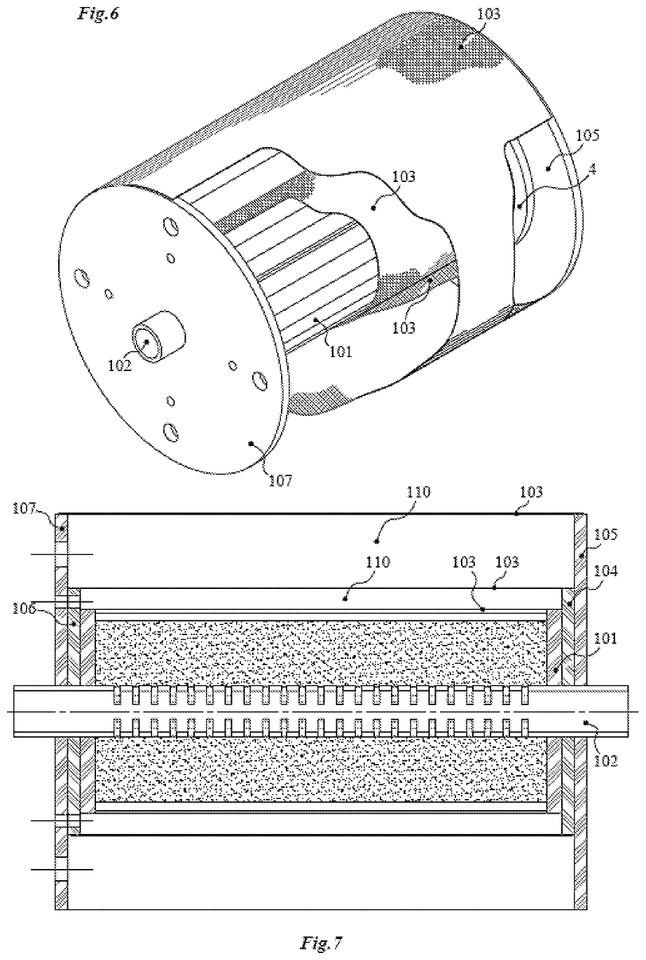

Another aspect of the instant disclosure, as shown in FIG. 6, is the addition of two more round discs, 105 without holes and 107 with holes, which are approximately twice the diameter of the pleated filter end discs, installed over the conveyance tube 102 on either end, with the center four holes of 107 aligned concentrically with each of the four holes in disc 105 previously installed. A two-ply screen system 103 can again be wrapped around axially onto the two outer discs, glued and trimmed, as shown in FIG. 7. This can create an outer void 110 area.

As shown in FIG. 8, the disclosed filtering system can then be filled with a first sterilizer compound 113, including for example, but not limited to, C3 Pellets (as disclosed in U.S. Pat. No. 9,650,265 and incorporated herein by reference), and a second nanoparticle sterilizer 114, and capped with push-in plugs 108 and 109. The second nanoparticle sterilizer 114 can in some embodiments comprise the nanoparticle sterilizer disclosed hereinabove. FIG. 8 also shows the direction of water-flow through the filter system, as it enters from the entire outer surface, through the first and second sterilizers, through the pleated filter, and out of the clean water conveyance tube 102.

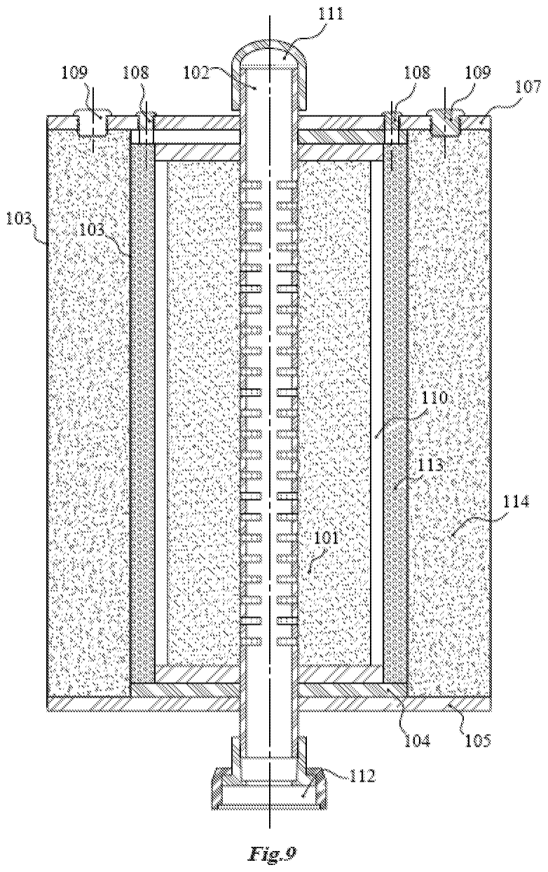

In some embodiments, and as shown in FIG. 9, the disclosed filtration devices and systems can be used for a secondary filtration system by aligning vertically, and using a finer particle size inner pleated filter, and the addition of a cap 111 installed on one end of the conveyance tube 102, and a fitting allowing removal on the other end. When combined in a complete system, all treated water can be free, or substantially free, of pathogens, bacteria, microbes and micro-bacterial organisms.

d. Wastewater Filtration Plant

Also provided herein, is a pressurized wastewater filtration plant, that can have a plurality, e.g. three or more, cylindrical processing vessels for progressive stages of filtration. By way of example and not limitation, the first cylindrical vessel can embody a pair of filters mounted on a manifold and residing on the bottom of the vessel. A second cylindrical vessel can embody a single filter to perform a second stage filtration process. A third cylindrical vessel can contain a series of elemental nanoparticle sterilizers, including those disclosed herein, that can perform a tertiary filtering of the filtrate wastewater. Wastewater can be conveyed to the primary vessel by any suitable means, including for example a bucket, hose, or similar device. The primary vessel can then be pressurized, e.g. to about thirty pounds, as observed by a gauge. Opening a valve along a conveyance located between the primary vessel and the secondary vessel, wastewater can then travel through the two filters in the primary vessel, along a conveyance, to the secondary vessel. The secondary vessel can then be pressurized, e.g. about thirty pounds, as observed by a gauge. Opening a second valve on the outflow of the secondary vessel can in some aspects permit the filtrate to convey to the third cylindrical vessel, that contains a series of chambers filled with varying elemental nanoparticle sterilizers for final polishing.

One proposed use for a system in accordance with the present disclosure is to process wastewater from an establishment such as a residence, small remote business, pond or stream, for use as pathogen free water, or substantially pathogen free water. In general, wastewater is conveyed to a primary vessel that embodies a pair of filters, to which the filtrate passes through after pressurization, to a secondary filtration vessel, that embodies a single filter. The filtrate then transfers to a third vessel after pressurization, which processes the final polishing of filtered water through the use of elemental nanoparticle technology, as disclosed hereinabove.

The forgoing aspects and many of the attendant advantages of this instant disclosure will become more readily appreciated as the same become better understood by reference to the below drawings.

Thus, disclosed herein is a pressurized wastewater filtration system that can be used to filter wastewater from an establishment, such as a single or multi family dwelling, or pond, stream or floodwaters (heron referred to as ‘wastewater’) so that the filtered water can be used for pathogen free water, or substantially pathogen free water.

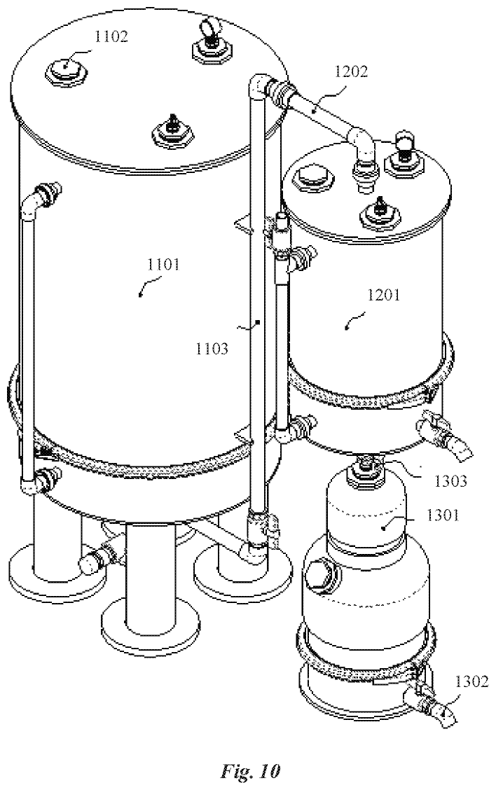

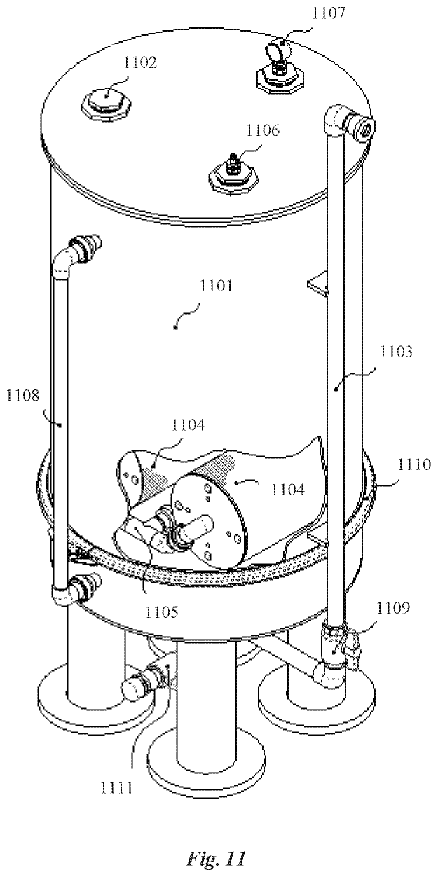

With reference to FIG. 10 being a basic operational view, the system can in some aspects comprise of a plurality, e.g. three, cylindrical vessels, including a primary vessel 1101, a secondary vessel 1201, and a tertiary vessel (reactor) 1301, whereby the primary vessel 1101 can be filled with wastewater through opening 1102. The processed wastewater will be transferred to the secondary vessel 1201 by means of the primary vessel out-flow conveyance pipe 1103 to the secondary vessel 1201 in-flow conveyance pipe 1202 wherein the filtrate may be processed and released to the tertiary vessel (reactor) 1301 by means of the tertiary vessel in-flow valve 1303 whereby the filtrate may go through final polishing, and extracted by fresh water outlet bib 1302.

Turning now to FIG. 11, another aspect of this system includes having wastewater conveyed by means of bucket, hose, or similar means to the primary vessel by filling it through the inlet port 1102 and observing the level through a sight tube 1108 until the level has reached the top of the sight tube. The primary containment vessel can be pressurized, e.g. to about 20 to 50 pounds, or about 30 pounds in some embodiments, by connecting an air source such as manual or battery, fossil, or renewable energy powered pump to the valve stem 1106 and observing level of pressure on gauge 1107, all located on the top of the vessel. When the pressure is released by opening primary vessel out-flow pipe 1103 flow control valve 1109, the wastewater can be forced through the exterior cylindrical surface of the filters 1104 that can be mounted to a manifold 1105 located at the bottom of the vessel. This can allow filtered water to pass to the secondary vessel. Excess wastewater that may be retained at the bottom of the vessel can be drained by opening drain valve 1111 located at the bottom exterior of the vessel.

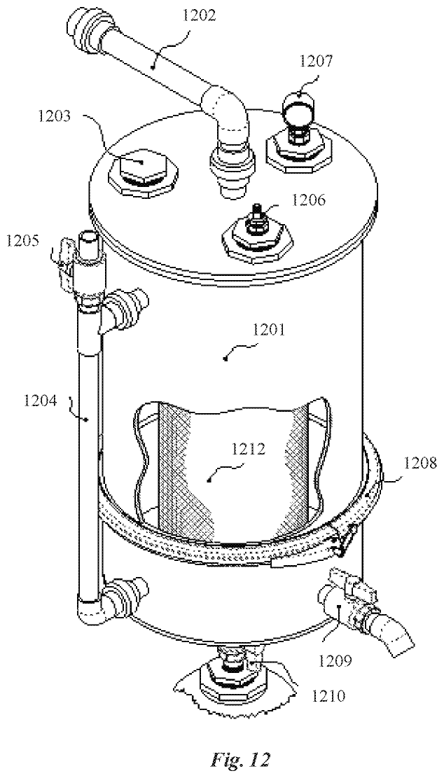

As shown in FIG. 12, filtered water from the primary vessel can be transferred to the secondary vessel by way of the secondary vessel in-flow conveyance pipe 1202 after opening vent 1205 and observing the level embodied by the vessel through the sight tube 1204 located on the front of the embodiment. The vessel can then be pressurized to thirty pounds by connecting an air source such as manual, fossil, or renewable energy powered pump to valve stem 1206 and observed pressure on gauge 1207. Upon release of pressure by means of opening transfer valve 1210 located beneath secondary vessel, filtered water can be forced through the exterior cylindrical surface of filter 1212 and pass to tertiary vessel. A sampling of the filtered water within the embodiment of secondary vessel for comparison can be taken at sampling bib 1209.

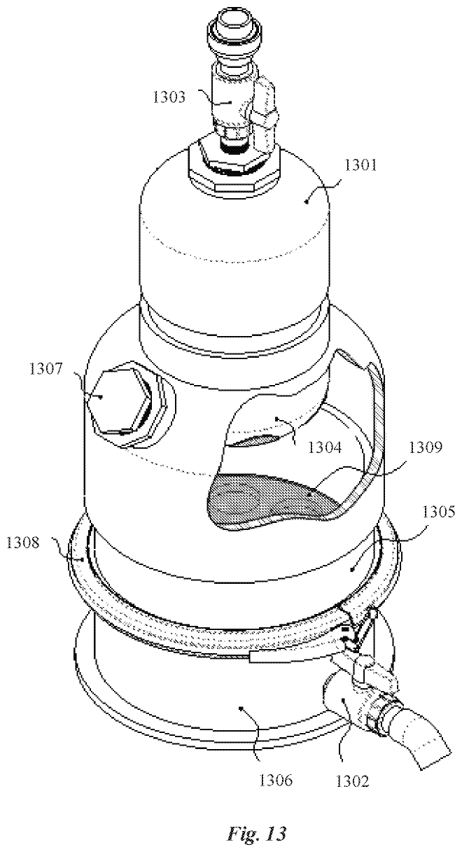

With reference to FIG. 13, the tertiary vessel (also referred to as a reactor) 1301 embodies three cylindrical chambers 1304, 1305 and 1306. The upper cylindrical chamber 1304 can contain a first sterilizer compound, including for example, but not limited to, C3 sterilizer pellets as disclosed in U.S. Pat. No. 9,650,265 and incorporated herein by reference. Cylindrical chamber 1305 has a screened bottom and can in some embodiments contain a nanoparticle sterilizer, as disclosed herein, that passes to a third chamber 1306 which may contain an enhanced GAC (EGAC), as disclosed herein. A final sampling of totally pathogen free water may be sampled at 1302 sampling bib.

### III. Examples

The following examples are included to further illustrate various embodiments of the presently disclosed subject matter. However, those of ordinary skill in the art should, in light of the present disclosure, appreciate that many changes can be made in the specific embodiments which are disclosed and still obtain a like or similar result without departing from the spirit and scope of the presently disclosed subject matter.

i. Effectiveness of Sintered Nanoparticle Sterilizer Compounds

Sintered nanoparticle sterilizers and/or compounds as disclosed herein were tested for efficacy in sterilizing wastewater. Raw sewage and seawater were collected and analyzed for various components and coliforms both in the absence and presence of the disclosed sintered nanoparticle compounds. Results of these tests are shown below in Tables 1 and 2. Table 1 summarizes the testing of raw sewage and seawater without treatment using sintered nanoparticle sterilizers. Table 2 summarizes the testing of sewage and seawater treated with sintered nanoparticle sterilizers disclosed herein.

TABLE 1
Analysis of Raw Sewage and Seawater Without Treatment Using Sintered Nanoparticle Sterilizers

| Analyses | Result | RL | Qual | Units | MCL | DF | Date Analyzed |
|---|---|---|---|---|---|---|---|
| ANIONS-SDWA (CL, F, | | | | EPA 300.0 | | | Analyst: K A |
| NO2, NO3, SO4) | | | | | | | |
| Chloride | 2830 | 5.00 | [symbol] | mg/L | 400 | 50 | 8/16/2018 |
| | | | | | | | 1:04:00 AM |
| Nitrate as N | ND | 5.00 | | mg/L | 10.0 | 50 | 8/16/2018 |
| | | | | | | | 1:04:00 AM |
| Nitrite as N | ND | 6.00 | | mg/L | 1.00 | 50 | 8/15/2018 |
| | | | | | | | 1:04:00 AM |
| CHLORINE, TOTAL | | | | SM 4500CL G | | | Analyst: K A |
| RESIDUAL-SDWA | | | | | | | |
| Chlorine, Total | ND | 0.0500 | CH | mg/L | 4.00 | 1 | 8/15/2018 |
| Residual | | | | | | | 5:16:00 PM |
| ODOR - SDWA | | | | SM 2150 B | | | Analyst: JCT |
| Odor | 70.0 | 1.00 | [symbol] | T.O.N. | 3.00 | 1 | 8/16/2018 |
| | | | | | | | 10:21:00 AM |
| PH - SDWA | | | | SM 4500H + B | | | Analyst: JCT |
| pH | 7.79 | 0 | H | pH Units | 8.50 | 1 | 8/15/2018 |
| | | | | | | | 5:04:00 PM |
| TOTAL SUSPENDED | | | | SM 2540D | | | Analyst: JCT |
| SOLIDS - SDWA | | | | | | | |
| Total Suspended | 85.0 | 5.00 | | mg/L | | 1 | 8/16/2018 |
| Solids | | | | | | | 8:37:00 AM |
| TURBIDITY - SDWA | | | | SM 2130 B | | | Analyst: SBK |
| Turbidity | 36.1 | 0.100 | [symbol] | NTU | 1.00 | 1 | 8/16/2018 |
| | | | | | | | 8:32:00 AM |
| COLIFORMS - MPN | | | | COLILERT-18 | | | Analyst: JCT |
| (DRINKING WATER) | | | | | | | |
| Coliform, Total | 81640000 | 10000 | | CFU/100 ml | | 10000 | 8/15/2018 |
| | | | | | | | 5:01:00 PM |
| Escherichia | 2620000 | 10000 | | CFU/100 ml | | 10000 | 8/15/2018 |
| Coli | | | | | | | 5:01:00 PM |
| HPC-SIMPLATE | | | | SM 9215 E | | | Analyst: JCT |
| Heterotrophic Plate | 9300000 | 1000000 | | CFU/mL | | 1000000 | 8/15/2018 |
| Count | | | | | | | 5:02:00 PM |

[symbol]

indicates data missing or illegible when filed

TABLE 2
Analysis of Sewage and Seawater Treated With Sintered Nanoparticle Sterilizers

| Analyses | Result | RL | Qual | Units | MCL | DF | Date Analyzed |
|---|---|---|---|---|---|---|---|
| ANIONS-SDWA (CL, F, | | | | EPA 300.0 | | | Analyst: K A |
| NO2, NO3, SO4) | | | | | | | |
| Chloride | 2520 | 5.00 | [symbol] | mg/L | 400 | 50 | 8/16/2018 |
| | | | | | | | 2:18:00 AM |
| Nitrate as N | 4.52 | 0.100 | | mg/L | 10.0 | 1 | 8/16/2018 |
| | | | | | | | 2:33:00 AM |
| Nitrite as N | ND | 0.100 | | mg/L | 1.00 | 1 | 8/16/2018 |
| | | | | | | | 2:33:00 AM |
| CHLORINE, TOTAL | | | | SM 4500CL G | | | Analyst: K A |
| RESIDUAL-SDWA | | | | | | | |
| Chlorine, Total | ND | 0.0500 | CH | mg/L | 4.00 | 1 | 8/15/2018 |
| Residual | | | | | | | 5:16:00 PM |
| ODOR-SDWA | | | | SM 2150 B | | | Analyst: JCT |
| Odor | 1.00 | 1.00 | | T.O.N. | 3.00 | 1 | 8/16/2018 |
| | | | | | | | 10:21:00 AM |
| PH-SDWA | | | | SM 4500H + B | | | Analyst: JCT |
| pH | 8.34 | 0 | H | pH Units | 8.50 | 1 | 8/15/2018 |
| | | | | | | | 5:04:00 PM |
| TOTAL SUSPENDED | | | | SM 2540D | | | Analyst: JCT |
| SOLIDS-SDWA | | | | | | | |
| Total Suspended | ND | 5.00 | | mg/L | | 1 | 8/16/2018 |
| Solids | | | | | | | 8:37:00 AM |
| TURBIDITY-SDWA | | | | SM 2130 B | | | Analyst: SBK |
| Turbidity | 0.630 | 0.100 | | NTU | 1.00 | 1 | 8/16/2018 |
| | | | | | | | 9:32:00 AM |
| COLIFORMS, | | | | COLILERT-18 | | | Analyst: JCT |
| E. COLI - MPN | | | | | | | |
| E. coli | ND | 1.00 | | CFU/100 ml | | 1 | 8/15/2018 |
| | | | | | | | 5:01:00 PM |
| COLIFORMS - MF, | | | | SM 9222 B | | | Analyst: JCT |
| TOTAL | | | | | | | |
| Coliform. Total | ND | 1.0000 | | CFU/100 ml | | 1 | 8/15/2018 |
| | | | | | | | 5:01:00 PM |
| HPC-SIMPLATE | | | | SM 9215 E | | | Analyst: JCT |
| Heterotrophic Plate | 287000 | 10000 | | CFU/mL | | 10000 | 8/16/2018 |
| Count | | | | | | | 5:02:00 PM |

[symbol]

indicates data missing or illegible when filed

The analytical results in Table 1 show high levels of coliforms, both total coliforms and E. Coli. The Heterotrophic Plate Count is also high. In marked contrast, the samples treated with the disclosed sintered nanoparticle sterilizers (Table 2) had undetectable levels (ND) of coliforms, as measured in total coliforms and E. Coli. Moreover, the Heterotrophic Plate Count was significantly reduced when treated with the disclosed sintered nanoparticle sterilizers.

These results clearly show the sterilization and anti-pathogenic properties of the disclosed sintered nanoparticle sterilizer compounds. With these properties the sintered nanoparticle sterilizers can be utilized for the sterilization of pathogens from processed water. As disclosed herein, and based on these anti-pathogenic properties, the sintered nanoparticles can be used in conjunction with one or more of the disclosed enhanced granulated activated charcoal (EGAC), water filters and water filtration systems, to treat, purify and/or sterilize raw water.

It will be understood that various details of the presently disclosed subject matter may be changed without departing from the scope of the presently disclosed subject matter. Furthermore, the foregoing description is for the purpose of illustration only, and not for the purpose of limitation.

What is claimed is:

1. A sintered nanoparticle compound comprising:
zeolite;
silver nitrate (AgNO₃);
a silver dioxide nanoparticle (Ag₂O np); and
graphene,
wherein the zeolite is a core element impregnated with the AgNO₃ and the Ag₂O np, wherein the impregnated zeolite core element is encapsulated in a graphene monolayer to form a sintered nanoparticle.

2. The sintered nanoparticle compound of claim 1, wherein the zeolite is organic, synthetic or a combination thereof.

3. The sintered nanoparticle compound of claim 1, wherein the sintered nanoparticle compound has an anti-pathogenic property.

4. The sintered nanoparticle compound of claim 3, wherein the sintered nanoparticle compound is configured to sterilize raw water, alone or in conjunction with a water filtration system.

5. The sintered nanoparticle compound of claim 1, wherein the zeolite comprises a substantially uniform particle size.

6. A method of sterilizing and/or treating water, the method comprising:
providing a sintered nanoparticle compound of claim 1; and
contacting water to be treated with the sintered nanoparticle compound,
wherein the water is sterilized and/or treated.

7. The method of claim 6, wherein the water to be treated is raw water.

8. A method of making a sintered nanoparticle compound, the method comprising:
providing a zeolite;
providing a silver nitrate (AgNO₃);
providing a silver dioxide nanoparticle (Ag₂O np);
providing a graphene;
combining a core element of the zeolite with a solution of AgNO₃ and/or Ag₂O np; and
mixing the solution to provide equal distribution,
whereby the zeolite core is impregnated with the AgNO₃ and/or Ag₂O np.

9. The method of claim 8, further comprising encapsulating the impregnated zeolite core with a monolayer of graphene to form a sintered nanoparticle compound.

10. The method of claim 8, further comprising placing the sintered nanoparticle compound in a negative pressure autoclave.

11. An enhanced granulated activated charcoal (EGAC) compound, comprising:
granulated activated charcoal;
silver nitrate (AgNO₃);
a silver dioxide nanoparticle (Ag₂O np); and
graphene,
wherein the granulated activated charcoal is an inner core impregnated with the AgNO₃ and Ag₂O np, wherein the impregnated granulated activated charcoal inner core is encapsulated in a graphene monolayer to form an EGAC.

12. The EGAC compound of claim 11, wherein the EGAC is configured to remove nitrates, nitrites, salts, odors, and/or taste from processed water.

13. The EGAC compound of claim 11, wherein the EGAC compound is configured for use in a water filtration system, and/or with sintered nanoparticle compounds.

14. A method of sterilizing and/or treating water, the method comprising:
providing an EGAC compound of claim 11,
contacting water to be treated with the EGAC compound,
wherein the water is sterilized and/or treated.

15. A method of making an enhanced granulated activated charcoal (EGAC) compound, the method comprising:
providing a granulated activated charcoal;
providing a silver nitrate (AgNO₃);
combining the granulated activated charcoal with a solution of AgNO₃ and mixing to uniformly combine the granulated activated charcoal with the AgNO₃ to form a granulated activated charcoal and AgNO₃ composite;
providing a silver dioxide nanoparticle (Ag₂O np) and mixing it with the granulated activated charcoal and AgNO₃ composite; and
placing the granulated activated charcoal with AgNO₃ and Ag₂O np in a negative pressure autoclave.

16. The method of claim 15, further comprising:
providing a graphene;
mixing the graphene with the granulated activated charcoal with AgNO₃ and Ag₂O np to substantially evenly coat the same.
